(19) United States
(12) Patent Application Publication
(10) Pub. No.: US 2008/0229046 A1
(43) Pub. Date: Sep. 18, 2008

(54) Unified support for solid state storage

(75) Inventor: Bohdan Raciborski, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/717,457

(22) Filed: Mar. 13, 2007

(51) Int. Cl. G06F 12/00

(52) U.S. Cl. 711/170

(57) ABSTRACT

In a method for providing unified support for solid state storage, a solid state storage class driver is provided to enable uniform operating system access to a plurality of dissimilar solid state storage devices. A common functionality of the plurality of dissimilar solid state storage devices is abstracted via a solid state storage port driver. A solid state storage bus driver is utilized to expose an interface feature of a solid state storage device, wherein the solid state storage device is selected from the plurality of dissimilar solid state storage devices such that the interface feature is accommodated while simultaneously enabling the operating system to support access to the plurality of dissimilar solid state storage devices in a unified manner.

### BACKGROUND

Historically, personal computers (PCs) have used hard drives as a means for persistent storage of user data and system data. Present hard drives are comprised of spinning magnetic media to which data is written from which data is read. These hard drives contain mechanical, moving parts that eventually wear out; this leads to failures and potential loss of data. These hard drives also consume more power, as their platters must almost continuously spin.

Going forward, a variety of non-volatile memory storage devices will begin to be used for persistent storage in place of, or in conjunction with, hard drives. Some examples of such non-volatile memory storage devices include: flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory, among others. Collectively, these non-volatile memory storage devices may be referred to as solid state storage or solid state storage devices. Such solid state storage is currently capable of being used in place of hard drives for persistent storage. Even so, use of solid state storage for persistent storage in PCs has been limited by the high price per Gigabyte of manufacturing solid state storage in comparison to the price per Gigabyte of manufacturing hard drives.

Recently though, the proliferation of mobile devices like digital cameras, digital audio players, and cellular phones have created such a large demand for solid state storage that prices have dropped. Prices for solid state storage are now low enough to consider solid state storage as an economical alternative to using hard drives for persistent storage in PCs.

The use of solid state storage for persistent storage in PCs offers several advantages over hard drives. For example, solid state storage has no moving parts, is smaller, lighter, consumes less power, and is less vulnerable to mechanical stress (such as jarring or shock impact).

Hard drives store data in sectors and clusters on specific platters which are accessible by hard drive heads. This requires mapping of memory access to a specific position on a platter of the spinning media of the hard drive. However, solid state storage provides direct access to each addressable memory cell, and thus requires no such mapping to a specific position on a spinning magnetic media.

Widespread use of solid state storage as persistent storage is in its infancy. Because of this, there is considerable competition between solid state storage technologies. For example, today consumers can choose from many solid state storage devices (some of which were mentioned above), which must be supported in some way by an operating system.

Presently, operating systems expose solid state storage to applications as if the solid state storage is another form of spinning media. This “spinning media model” requires drivers for such solid state storage to access the solid state storage as if it has the same types of mechanical parts (sectors, platters, cylinders, heads, and the like) and mechanical limitations as a hard drive. Spinning media latencies are built into data access requests to compensate for the slowness of the moving parts, such as head seek time, even though such latencies are not required when accessing data in solid state storage. This data access paradigm wastes time and complicates solid state storage data access for the operating system and for applications. Additionally, treating solid state storage as if it is spinning media requires that a specific high level driver (such as a port driver) be designed for nearly every competing solid state storage technology. This places a significant burden on the manufacturers of solid state storage solutions.

Thus, a technology which addresses some of the above disadvantages and shortcomings associated with using solid state storage as persistent storage in a PC would be advantageous.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a method for providing unified support for solid state storage, a solid state storage class driver is provided to enable uniform operating system access to a plurality of dissimilar solid state storage devices. A common functionality of the plurality of dissimilar solid state storage devices is abstracted via a solid state storage port driver. A solid state storage bus driver is utilized to expose an interface feature of a solid state storage device, wherein the solid state storage device is selected from the plurality of dissimilar solid state storage devices such that the interface feature is accommodated while simultaneously enabling the operating system to support access to the plurality of dissimilar solid state storage devices in a unified manner.

Providing unified support for solid state storage in the above described manner creates unique solid state storage abstraction layers in the storage stack associated with an operating system. These unique solid state storage abstraction layers allow data accesses to a plurality of dissimilar solid state storage technologies to look identical to an operating system and applications running thereon. Providing unique solid state storage abstraction layers eliminates operating system dependencies on the “spinning media model” for accessing solid state storage. This simplifies and streamlines the current methods of accessing solid state storage by freeing the operating system, and applications running thereon, to access solid state storage without the latencies and inefficiencies imposed when accessing solid state storage as it if it is another form of spinning media.

### DESCRIPTION OF THE DRAWINGS

The accompanying drawings, which are incorporated in and form a part of this specification, illustrate embodiments of the technology for unified support for solid state storage and, together with the description, serve to explain principles discussed below:

FIG. 1 is a diagram of an example computer system used in accordance with embodiments of the present technology for unified support for solid state storage.

FIG. 2 shows an example storage stack associated with an operating system, according to one embodiment of the present technology.

FIG. 3 is an example flow diagram of operations performed in a method for providing unified support for solid state storage, in accordance with one embodiment of the present technology.

FIG. 4 is an example flow diagram of operations performed in a method of accessing a solid state storage device, in accordance with one embodiment of the present technology.

The drawings referred to in this description should be understood as not being drawn to scale unless specifically noted.

### DETAILED DESCRIPTION

Reference will now be made in detail to embodiments of the present technology for unified support for solid state storage, examples of which are illustrated in the accompanying drawings. While the technology for unified support for solid state storage will be described in conjunction with various embodiments, it will be understood that they are not intended to limit the present technology for unified support for solid state storage to these embodiments. On the contrary, the presented embodiments of the technology for unified support for solid state storage are intended to cover alternatives, modifications and equivalents, which may be included within the spirit and scope the various embodiments as defined by the appended claims. Furthermore, in the following detailed description, numerous specific details are set forth in order to provide a thorough understanding of embodiments of the present technology for unified support for solid state storage. However, embodiments of the present technology for unified support for solid state storage may be practiced without these specific details. In other instances, well known methods, procedures, components, and circuits have not been described in detail as not to unnecessarily obscure aspects of the present embodiments.

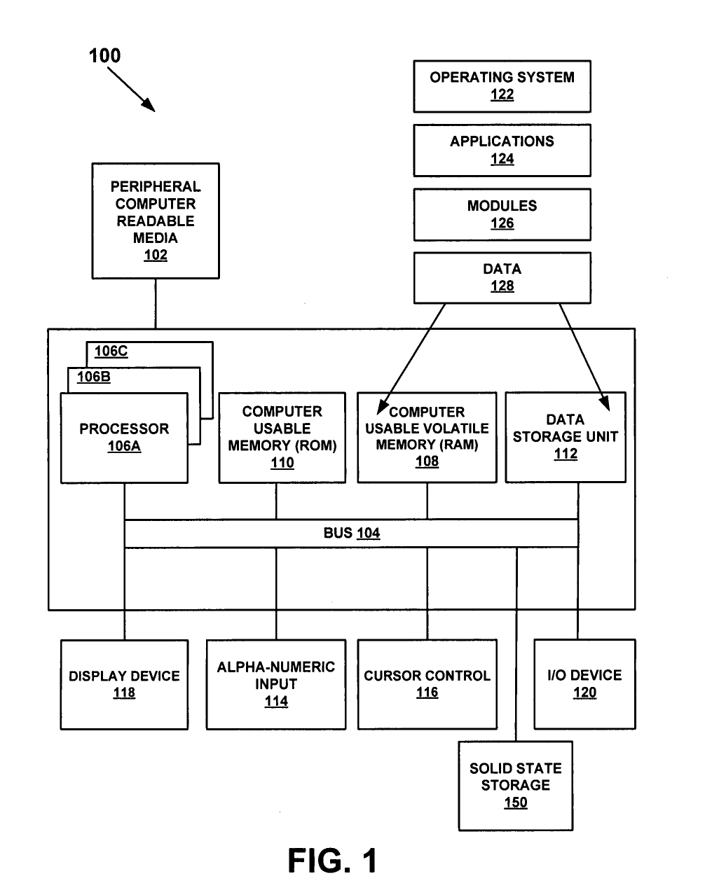

Unless specifically stated otherwise as apparent from the following discussions, it is appreciated that throughout the present detailed description, discussions utilizing terms such as “providing”, “abstracting”, “utilizing”, “exposing”, “defining”, “facilitating”, “receiving”, “supporting”, or the like, refer to the actions and processes of a computer system (such as computer 100 of FIG. 1), or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Some embodiments of the present technology for unified support for solid state storage are also well suited to the use of other computer systems such as, for example, optical and virtual computers.

### Overview of Discussion

Discussion will begin with a description of an example computer system environment with which, or upon which, embodiments of the present technology may operate. Discussion will proceed to a description of an example storage stack associated with an operating system. The example storage stack comprises several modules that create abstraction layers in the storage stack which are unique to solid state storage. These unique solid state storage abstraction layers allow data accesses to a plurality of dissimilar solid state storage devices to look identical to an operating system and applications running thereon. In this manner, unified support for a plurality of dissimilar solid state storage devices is provided. A general description of the storage stack will be provided, along with more in depth discussion of the modules that create the unique solid state storage abstraction layers. Operation of the storage stack and the unique solid state storage abstraction layers will then be described in more detail in conjunction with a description of an example method for providing unified support for solid state storage, and also in conjunction with an example method for accessing a solid state storage device.

### Example Computer System Environment

With reference now to FIG. 1, all or portions of some embodiments of the technology for unified support for solid state storage are composed of computer-readable and computer-executable instructions that reside, for example, in computer-usable media of a computer system. That is, FIG. 1 illustrates one example of a type of computer that can be used to implement embodiments, which are discussed below, of the present technology for unified support for solid state storage. FIG. 1 illustrates an example computer system 100 used in accordance with embodiments of the present technology for unified support for solid state storage. It is appreciated that system 100 of FIG. 1 is only an example and that embodiments of the present technology for unified support for solid state storage can operate on or within a number of different computer systems including general purpose networked computer systems, embedded computer systems, routers, switches, server devices, client devices, various intermediate devices/nodes, stand alone computer systems, media centers, handheld computer systems, and the like.

As shown in FIG. 1, computer system 100 is well adapted to having peripheral computer readable media 102 such as, for example, a floppy disk, a compact disc, and the like coupled thereto. Additionally, as shown in FIG. 1, computer system 100 is well adapted to having a solid state storage 150, which may be fixed (non-removable) or removable, coupled thereto. Flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory provide some specific examples of such a solid state storage 150.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive or a solid state storage such as a flash memory) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118 and indicate user selections of selectable items displayed on display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands. System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet.

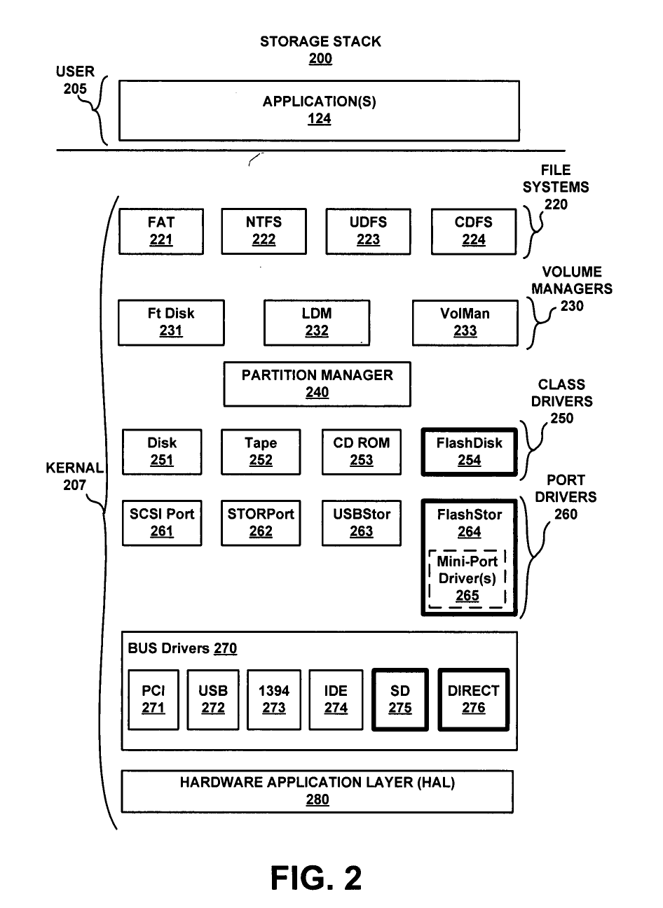

Referring still to FIG. 1, various other components are depicted for system 100. Specifically, when present, all or portions of operating system 122, applications 124, modules 126, and data 128 are shown as typically residing in one or some combination of computer usable volatile memory 108, e.g. random access memory (RAM), and data storage unit 112. However, it is appreciated that in some embodiments, operating system 122 may be stored in other locations such as on a network or on solid state storage 150; and that further, operating system 122, applications 124, modules 126, and/or data 128 may be accessed from a remote location via, for example, a coupling to the Internet. Additionally, operating system 122 may comprise or be associated with a kernel 207 (FIG. 2), which is used to abstract features of mass storage devices.

In some embodiments, all or part of the present technology for unified support for solid state storage is stored as an operating system 122, application 124, module 126, or some combination thereof, in memory locations within RAM 108, media within data storage unit 112, and/or media of peripheral computer readable media 102. Likewise, in some embodiments, all or part of the present technology for may be stored at a separate location from computer 100 and accessed via, for example, a coupling to the Internet.

### Storage Stack

Referring now to FIG. 2, FIG. 2 shows storage stack 200 according to one embodiment of the present technology. Storage stack 200 is associated with a personal computer operating system, such as operating system 122. It is appreciated, that storage stack 200 may be associated with a wide variety of personal computer operating systems. By way of example, and not of limitation, “Microsoft Windows Vista” is one example of an operating system 122 which storage stack 200 may be associated with.

In general, storage stack 200 provides a series of abstraction layers between a storage device, such as a mass storage device (112, 150), and an application running on an operating system. As depicted, storage stack 200 is arranged vertically with an application, such as application 124, shown at the top of stack 200. Application 124 is utilized by a user 205 to perform some function on or with a computer system, such as, for example, computer system 100. It is appreciated that multiple applications may be associated with stack 200 in the manner illustrated herein by application 124. Each layer below application 124 provides an abstraction of a mass storage device (112, 150), with abstractions nearer the top of kernel 207 being generalized, and becoming more detailed at each successively lower layer in stack 200. In this manner, each abstraction layer serves as an interface to the layer below it. Likewise, in this manner, application 124 requires only generalized information, such as information about a file system, in order to access data on a mass storage device (112, 150).

In the example embodiment illustrated by FIG. 2, Storage stack 200 is comprised of an application 124 which may be used by or accessed by user 205, and a kernel 207 which is associated with, or part of, an operating system 122. Kernel 207 is comprised of a plurality of abstraction layers. These abstraction layers include file systems 220, volume managers 230, partition manager 240, class drivers 250, port drivers 260, bus drivers 270, and hardware abstraction layer 280.

### File Systems Layer

The operation of the file systems 220 abstraction layer is generally known in the art. File systems 220 are communicatively coupled to application 124 and to operating system 122. In general, with respect to file systems 220, data to be accessed is exposed to application 124 as one or more files which may be arranged in folders. Accessing data, as described herein encompasses acts of reading, writing, and searching data. As shown, the file systems 220 abstraction layer is comprised of one or more modules, such as FAT (File Allocation Table) 221, NTFS (New Technology File System) 222, UDFS (Universal Disk File System) 223, and CDFS (Compact Disk File System) 224, and potentially other modules for other storage media and/or storage techniques. File systems such as FAT 221, NTFS 222, UDFS 223, and CDFS 224, are known in the art. Each of these file system modules (e.g., 221, 222, 223, 224, and the like) exposes a file system for a different type of storage media and/or exposes a file system via particular storage technique. In one instance, file systems 220 may also comprise a module for exposing a file system for a solid state storage device. In other instances, where the file system for solid state storage devices is similar or identical to that of another storage device (such as a disk), the file system module utilized by a computer system for that type of storage device (e.g., UDFS 221) may be used to expose the file system of a solid state storage device.

### Volume Managers Layer

The operation of the volume managers 230 abstraction layer is also generally known in the art. Volume managers 230 are communicatively coupled to file systems 220. In general, with respect to the volume managers 230 abstraction layer, data or a location to be accessed is exposed to file systems 220 as “volume(s)” in the form of space allocated on one or more mass storage devices, such as, for example, a disk drive or a solid state storage device. Such volumes may be actual physical volumes or may be virtual volumes, and may be located in a variety of locations. Additionally, such volumes may be comprised of one or more partitions (exposed by partition manager 240). As shown, the volume managers 230 abstraction layer is comprised of one or more modules, such as “FtDisk” (fault tolerant disk) 231, “LDM” (Logical Disk Manager) 232, and VolMan (logical volume manager) 233. Each of these modules (e.g., 231, 232, 233, and the like) exposes to file systems 220 one or more volumes which are available for data access. In a typical personal computer system, such as computer system 100, these volumes may be represented by designators such as “A:”, “B:”, “C:” and the like, which may be designated automatically or by user 205. These volumes are often colloquially referred to as “drives”, for example, “the C drive,” even though such volumes may not reside on spinning media.

### Partition Manager Layer

The operation of the partition manager 240 abstraction layer is also generally known in the art. Partition manager 240 is communicatively coupled to volume managers 230. In general, with respect to the partition manager 240, data or a location to be accessed is exposed to volume managers 230 as partitions in the form of space allocated on one or more mass storage devices, such as, for example, a disk drive or a solid state storage device. Typically, each volume is comprised of one or more partitions. In most cases there is a one to one mapping between a volume and a partition. However, when a volume is comprised of multiple partitions, the partitions may reside on a single mass storage device (112,150), or upon a plurality of different mass storage devices (112,150).

### Class Drivers Layer

In general, the class drivers 250 abstraction layer provides abstracted intrinsic information regarding mass storage devices (112,150). Class drivers 250 are communicatively coupled to partition manager 240. The concepts of operation of several of the modules (Disk 251, Tape 252, and CD ROM 253) of the class drivers 250 abstraction layer are generally known in the art. In existing technology, for example, disk 251 module provides an abstraction of intrinsic information unique to disk drives which are comprised of spinning media. This allows an operating system 122 to transparently access a wide variety of dissimilar types of spinning media in a uniform manner. Additionally, existing technology typically relies upon disk 251 module to access solid state storage, even though solid state storage is not physically similar to spinning media.

The present technology for unified support for solid state storage adds another module, “FlashDisk” 254, to the modules of class drivers 250. “FlashDisk” 254 is a solid state storage class driver, which allows data access to solid state storage without the encumbrances a “spinning media model” would impose upon a solid state storage data access routed through disk 251 module. “FlashDisk” 254 module abstracts intrinsic information regarding a solid state storage device. In one embodiment, “FlashDisk” 254 module abstracts intrinsic information regarding a plurality of dissimilar solid state storage devices, such as: flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory.

One example of such abstracted intrinsic information is abstracted intrinsic information regarding whether a particular solid state storage device is removable from a personal computer system, such as computer system 100. Another example of such abstracted intrinsic information is abstracted intrinsic information regarding whether a particular solid state storage device is a fixed, non-removable portion of a personal computer system, such as computer system 100. Yet another example of such abstracted intrinsic information is abstracted intrinsic information regarding whether a particular solid state storage device may be used to boot a personal computer system, such as computer system 100. “FlashDisk” 254 provides or “exposes” this abstracted intrinsic information regarding one or more solid state storage devices to partition manager 240. In this manner, “FlashDisk” 254 supports unified access through an operating system, such as operating system 122, to a plurality of dissimilar solid state storage devices. Unified access allows a plurality of dissimilar solid state storage devices to “look” the same to partition manager 240, thus simplifying access to dissimilar devices.

### Port Drivers

In general, the port drivers 260 abstraction layer provides one or more modules which comprise abstracted information related to one or more common characteristics of a plurality of dissimilar mass storage devices (112, 150). Port drivers 260 are communicatively coupled to class drivers 250. The concepts of operation of several of the modules (“SCSI Port” 261, “STORPort” 262, and “USBStor” 263) of the port drivers 260 abstraction layer are generally known in the art. In existing technology, for example, “SCSI Port” 261 abstracts common features of a plurality of dissimilar SCSI (Small Computer System Interface) devices. By abstracting these common features, the manufacturer of an SCSI device is not required to write a full blown port driver for the SCSI device, but rather only a small mini-port driver which exposes the unique features of the SCSI device which are different or additional to the common features abstracted in “SCSI Port” 261 module.

The present technology for unified support for solid state storage adds a solid state storage port driver (“FlashStor” 264) to the modules of port drivers 260 abstraction layer. The “FlashStor” 264 module provides abstracted information related to one or more common characteristics of a plurality of dissimilar solid state storage devices. For example, while the solid state storage devices may be mechanically dissimilar or have a dissimilar pinouts, they share one or more common characteristics such as, for example: information utilized to describe size of a storage area, a mechanism for presenting a data packet to be stored, or a mechanism for retrieving a stored portion of data packet. The “FlashStor” 264 module abstracts common features of a plurality of dissimilar solid state storage devices, such as: flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory.

In one instance, some such common characteristics are abstracted into a common communication protocol for uniformly accessing a plurality of solid state storage devices from an operating system. For example, such a communication protocol may comprise a standard format for packaging data sent for storage on a solid state storage device. By abstracting these common features, the manufacturer of a solid state storage device is not required to write a full blown port driver for the solid state storage device, but rather only a small mini-port driver which exposes the unique features of the solid state storage device which are different or additional to the common features abstracted in the “FlashStor” 264 module.

### Mini-Port Drivers

Mini-port drivers are optional port drivers which contain information about one or more unique features of a solid state storage device which is/are different than or in addition to the common features which are abstracted in the solid state storage port driver. The present technology allows for the optional addition of a mini-port driver, such as mini-port driver 265, which exposes the one or more unique features of a particular solid state storage device to a solid state storage port driver, such as “FlashStor” 264 module. For example, in one embodiment, an OEM (Original Equipment Manufacturer) for a USB Flash Drive writes and provides a mini-port driver that interfaces with “FlashStor” 264 to expose the unique, non-commonly abstracted features of the USB Flash Drive to the “FlashStor” 264 module.

### Bus Drivers

In general, the bus drivers 270 abstraction layer provides one or more modules, each of which exposes an interface feature or features of a component which may be coupled to a bus, such as bus 104 of personal computer 100. Bus drivers 270 are communicatively coupled to port drivers 260 and expose the interface feature or features of a component to port drivers 260. The concepts of operation of several of the modules (PCI (Peripheral Component Interface) 271, USB (Universal Serial Bus) 272, “1394” (Institute of Electrical and Electronics Engineers 1394 interface) 273, and IDE (Integrated Development Environment) 274) of the bus drivers 270 abstraction layer are generally known in the art. In existing technology, for example, USB 271 module provides specific information regarding coupling to and exchanging data via a Universal Serial Bus such as a USB 2.0 standard bus.

The present technology for unified support for solid state storage adds one or more solid state bus driver modules (e.g., “SD” 275 and “Direct” 276) to the modules of bus drivers 270. “SD” 275 module, for example, provides interface information associated with coupling to and accessing data with respect to a “SecureDigital” solid state storage device. Likewise, a variety of such solid state storage bus drivers may be included in bus drivers 270 abstraction layer to provide interface information for other solid state storage devices, such as: flash memory, “SecureDigital” memory, Universal Serial Bus (USB) flash memory, “MultiMediaCard” (“MMC”) memory, “extreme Digital” (“XD”) memory, “CompactFlash” memory, “MemoryStick” memory, and “SmartMedia” memory. In another example, “Direct” 276 module provides interface information for coupling to and accessing data with respect to a solid state storage device, such as a flash memory, which is soldered or otherwise directly coupled to a motherboard of a computer, such as computer system 100. Such solid state storage bus drivers expose specific configuration information regarding a solid state storage device. For example, interface information exposed may be a specific protocol or specific communication information required to properly interface a particular solid state storage device with a bus, such as bus 104 of a computer system 100.

### Hardware Application Layer

“HAL” (Hardware Abstraction Layer) 280 is used to separate the actual hardware from the operating system. “HAL” 280 is communicatively coupled with bus drivers 270. “HAL” 280 comprises code that produces an interface between hardware and any software (such as application 124 or operating system 122) using it. “HAL” 280 abstracts, or hides, any remaining non-exposed or abstracted hardware-dependent details from the other layers of kernel 207. The operation and construction of a hardware application layer such as “HAL” 280 is well known in the art.

### Example Methods of Operation

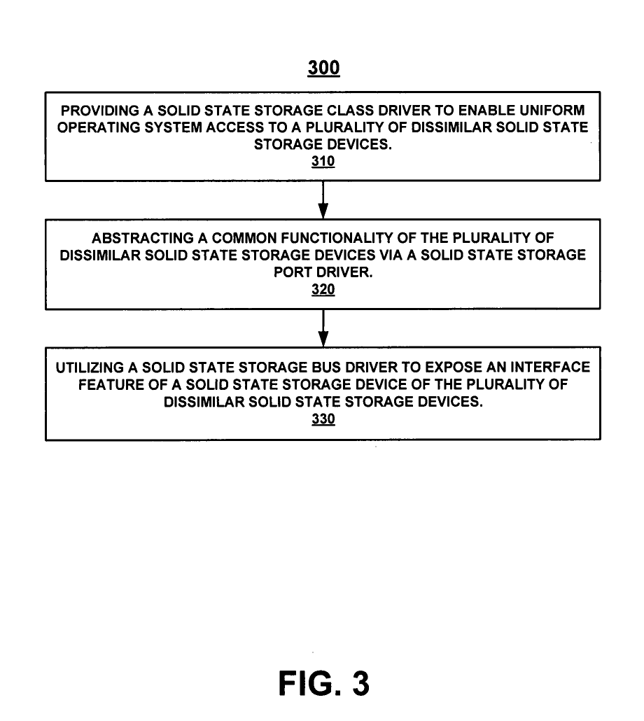

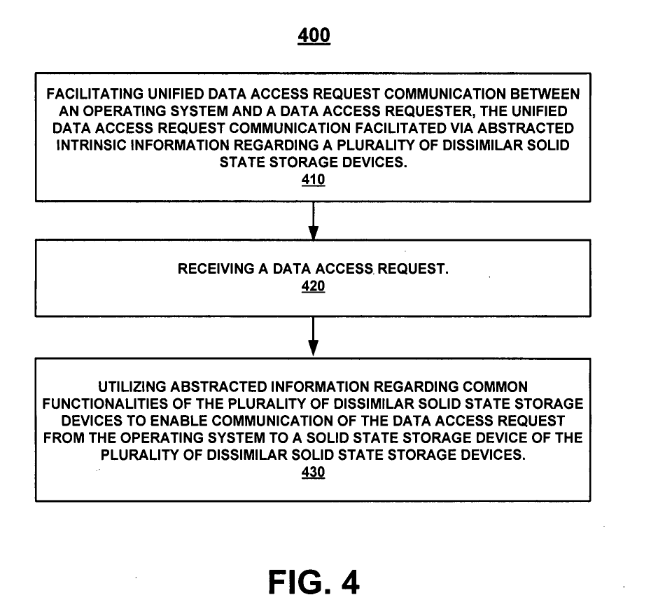

The following discussion sets forth in detail the operation of some example methods of operation of embodiments of the present technology for unified support for solid state storage. With reference to FIG. 3 and FIG. 4, flow diagrams 300 and 400 each illustrate example steps used by various embodiments of the present technology for unified support for solid state storage. Flow diagrams 300 and 400 include processes that, in various embodiments, are carried out by a processor under the control of computer-readable and computer-executable instructions. The computer-readable and computer-executable instructions reside, for example, in data storage features such as computer usable/readable volatile memory 108, computer usable/readable non-volatile memory 110, peripheral computer-readable media 102, and/or data storage unit 112 of FIG. 1. The computer-readable and computer-executable instructions, which may reside on computer useable/readable media, are used to control or operate in conjunction with, for example, processor 106A and/or processors 106A, 106B, and 106C of FIG. 1. Although specific steps are disclosed in flow diagrams 300 and 400, such steps are examples. That is, embodiments are well suited to performing various other steps or variations of the steps recited in flow diagrams 300 and 400. It is appreciated that the steps in flow diagrams 300 and 400 may be performed in an order different than presented, and that not all of the steps in flow diagrams 300 and 400 may be performed.

### Providing Unified Support for Solid State Storage

FIG. 3 illustrates a flow diagram 300 of an example embodiment of a method for providing unified support for solid state storage. Elements of flow diagram 300 are described below, with reference to elements of FIG. 1 and FIG. 2.

At step 310 of flow diagram 300, in one embodiment, the method provides a solid state storage class driver to enable uniform operating system access to a plurality of dissimilar solid state storage devices. In one embodiment, this comprises providing a solid state class driver, such as “FlashDisk” 254. As discussed above, such a solid state class driver abstracts intrinsic information regarding a plurality of dissimilar solid state storage devices. Such a plurality of dissimilar solid state storage devices may include solid state storage such as: flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory, among others.

In one embodiment, the solid state storage class driver provides abstracted intrinsic information to a portion of a storage stack, such as partition manager 240 of storage stack 200. Providing abstracted intrinsic information hides details about the plurality of dissimilar storage devices, such that each of the dissimilar solid state storage devices appears the same when viewed by the operating system of a computer. Thus, the operating system of a computer is able to access each of a plurality of dissimilar solid state storage devices in a uniform manner, as if the dissimilar devices were identical in nature.

In one instance, providing abstracted intrinsic information comprises exposing whether a particular solid state storage device is fixedly coupled to a computer system. An example of a fixed solid state storage device is a flash memory that is soldered to a motherboard of a computer system. In one instance, providing abstracted intrinsic information comprises exposing whether a particular solid state storage device is removable from a computer system. An example of a removable solid state storage device is a card based solid state storage device, such as a “SecureDigital” memory card. In one instance, providing abstracted intrinsic information comprises exposing whether a particular solid state storage device is bootable by a computer system.

At step 320 of flow diagram 300, in one embodiment, the method abstracts a common functionality of the plurality of dissimilar solid state storage devices via a solid state storage port driver. In one embodiment, for example, one or more common functionalities are abstracted into a solid state storage port driver, such as “FlashStor” 264 of FIG. 2. In another embodiment, an existing port driver, such as “USBStor” 263, can be extended and/or enhanced to provide the solid-state storage capabilities on a specific bus (e.g., a Universal Serial Bus). This would provide better backward compatibility with solid state storage devices currently available. As discussed above, a solid state storage port driver, such as “FlashStor” 264 or an extended/enhanced “USBStor” 263, may be used to define a protocol, such as a communication protocol, for accessing one or more of a plurality of the dissimilar solid state storage devices. Abstracting features and functionality which are common to the plurality of dissimilar solid state storage devices eliminates the necessity of providing a separate “full-blown” solid state storage port driver containing every feature of a solid state storage device. It follows that this also eliminates the necessity for having such a “full-blown” port driver for each of the plurality of dissimilar solid state storage devices.

In one embodiment, step 320 further comprises enabling a unique feature of a solid state storage device to be exposed via a solid state storage mini-port driver. In such an embodiment, the solid state storage device is selected from the previously described plurality of dissimilar solid state storage devices. In this manner, the unique feature of the solid state storage is accommodated by a storage stack, such as storage stack 200, while the storage stack simultaneously enables an operating system, such as operating system 122, to support access to the plurality of dissimilar solid state storage devices in a unified manner. For example, this may comprise allowing an OEM to provide a mini-bus driver, such as mini-bus driver 265, which interfaces with a solid state storage port driver, such as “FlashStor” 264 to expose one or more unique, non-commonly abstracted features of a particular solid state storage device.

At step 330 of flow diagram 300, in one embodiment, the method utilizes a solid state storage bus driver to expose an interface feature of a solid state storage device. In such an embodiment, the solid state storage device is selected from the previously described plurality of dissimilar solid state storage devices. In this manner, the interface feature of the solid state storage is accommodated by a storage stack, such as storage stack 200, while the storage stack simultaneously enables an operating system, such as operating system 122, to support access to the plurality of dissimilar solid state storage devices in a unified manner. In one embodiment, for example, one or more common interface functionalities of a single solid state storage device are abstracted into a solid state storage bus driver, such as “SD” 275 or “Direct” 276 of storage stack 200. As previously discussed, such a solid state storage bus driver may be used for exposing specific configuration information regarding coupling a solid state storage device to a bus, such as bus 104, of computer system 100. It is appreciated that at step 330, a plurality of such solid state storage bus drivers may be utilized, with each of the plurality of solid state storage bus drivers being associated with the interface requirements associated with one of the plurality of dissimilar solid state storage devices.

### Accessing a Solid State Storage Device

FIG. 4 illustrates a flow diagram 400 of an example method for accessing a solid state storage device. Elements of flow diagram 400 are explained below, with reference to elements of FIG. 1, FIG. 2, and FIG. 3.

At step 410 of flow diagram 400, in one embodiment, the method facilitates unified data access request communication between an operating system and a data access requester. The unified data access request communication is facilitated via abstracted intrinsic information regarding a plurality of dissimilar solid state storage devices. Such a plurality of dissimilar solid state storage devices may include solid state storage such as: flash memory, Universal Serial Bus (USB) flash memory, “Secure Digital” (“SD”) memory, “MultiMediaCard” (“MMC”) memory, “extreme Digital” (“XD”) memory, “CompactFlash” memory, “MemoryStick” memory, and “SmartMedia” memory, among others.

Step 410 is similar to step 310 of flow diagram 300. In one embodiment, for example, unified data access request communication is facilitated by providing a solid state storage class driver, such as “FlashDisk” 254. This allows a storage stack, such as storage stack 200 to uniformly access a plurality of dissimilar solid state storage devices without using spinning media models or abstractions. This eliminates many inefficiencies and latencies that are introduced by assessing solid state storage via spinning media models or abstractions. As previously discussed, abstracted intrinsic information may comprise the solid state storage class driver exposing a fixed nature of a solid state storage device being accessed, exposing a removable nature of the solid state storage device being accessed, and/or exposing information which facilitates booting a computer system from the solid state storage device being accessed.

At step 420 of flow diagram 400, in one embodiment, the method receives a data access request in the operating system. The data access request may be a read request, write request, or search request. The data access request can be received from a data access requester. In one instance, the data access requester is a portion of an operating system, such as operating system 122. In one instance, the data access requester is an application, such as application 124. The data access request is directed toward a solid state storage device, which may be either a fixed or removable solid state storage device. One example of a fixed device is a flash memory which is soldered to or otherwise fixedly coupled to the motherboard of a computer system, such as computer system 100. One example of a removable solid state storage device is a USB flash drive, colloquially known as a “thumb drive” or a “keychain drive”.

At step 430 of flow diagram 400, in one embodiment, the method utilizes abstracted information regarding common functionalities of the plurality of dissimilar solid state storage devices to enable communication of the data access request from the operating system to a solid state storage device of the plurality of dissimilar solid state storage devices. This allows the operating system to support access to the plurality of dissimilar solid state storage devices in a unified manner. Thus, while the devices may be different from one another, they are made to look similar when accessed by an operating system or an application running thereon. As previously described, such common functionalities may be abstracted via a solid state storage port driver, such as “FlashStor” 264. In one instance, for example, the solid state storage port driver defines a common communication protocol for uniformly accessing the plurality of dissimilar solid state storage devices. Such a communication protocol may define, for example, a common means of packetizing data sent to or received from a solid state storage device in response to a data access request.

In one embodiment, flow diagram 400 of FIG. 4 further comprises a step of exposing an interface feature of the solid state storage device being accessed. This can be accomplished, for example, using a solid state storage bus driver that exposes specific configuration information regarding the solid state storage device being accessed. This can be done for the purpose of coupling the solid state storage device with a bus of a computer system. For example, assume that a “SecureDigital” memory is being accessed by operating system 122 or application 124 via method 400. In this example, solid state storage bus driver “SD” 275 will expose interface features of the “SecureDigital” memory so that it can be communicatively coupled with bus 104 of computer system 100 and thereby accessed by operating system 104 or application 124.

In one embodiment, flow diagram 400 of FIG. 4 further comprises a step of exposing a unique, non-commonly abstracted feature of the solid state storage device being accessed. This can be accomplished, for example, allowing a solid state storage port driver, such as “FlashStor” 264 module to access a solid state storage mini-port driver, such as mini-port driver 265, which exposes specific configuration information regarding a particular solid state storage device being accessed.

Example embodiments of the present technology for unified support for solid state storage are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing unified support for solid state storage, said method comprising:
providing a solid state storage class driver to enable uniform operating system access to a plurality of dissimilar solid state storage devices;
abstracting a common functionality of said plurality of dissimilar solid state storage devices via a solid state storage port driver; and
utilizing a solid state storage bus driver to expose an interface feature of a solid state storage device, wherein said solid state storage device is selected from said plurality of dissimilar solid state storage devices, such that said interface feature is accommodated while simultaneously enabling said operating system to support access to said plurality of dissimilar solid state storage devices in a unified manner.

2. The method as recited in claim 1, wherein said providing a solid state storage class driver to enable uniform operating system access to a plurality of dissimilar solid state storage devices comprises:
abstracting intrinsic information regarding said plurality of dissimilar solid state storage devices.

3. The method as recited in claim 2, wherein said abstracting intrinsic information regarding said plurality of dissimilar solid state storage devices comprises:
exposing said solid state storage device as a fixed portion of a computer system.

4. The method as recited in claim 2, wherein said abstracting intrinsic information regarding said plurality of dissimilar solid state storage devices comprises:
exposing said solid state storage device as a removable from a computer system.

5. The method as recited in claim 2, wherein said abstracting intrinsic information regarding said plurality of dissimilar solid state storage devices comprises:
exposing said solid state storage device as bootable by a computer system.

6. The method as recited in claim 1, wherein said abstracting a common functionality of said plurality of dissimilar solid state storage devices via a solid state storage port driver comprises:
defining a protocol for accessing said plurality of dissimilar solid state storage devices.

7. The method as recited in claim 1, wherein said abstracting a common functionality of said plurality of dissimilar solid state storage devices via a solid state storage port driver further comprises:
enabling a unique feature of said solid state storage device to be exposed via a mini-port driver.

8. The method as recited in claim 1, wherein said utilizing a solid state storage bus driver to expose an interface feature of a solid state storage device comprises:
exposing specific configuration information regarding coupling said solid state storage device to a bus of a computer system.

9. A computer-readable medium having computer-executable instructions for performing a method of accessing a solid state storage device, said method comprising steps of:
facilitating unified data access request communication between an operating system and a data access requester, said unified data access request communication facilitated via abstracted intrinsic information regarding a plurality of dissimilar solid state storage devices;
receiving a data access request in said operating system; and
utilizing abstracted information regarding common functionalities of said plurality of dissimilar solid state storage devices to enable communication of said data access request from said operating system to a solid state storage device of said plurality of dissimilar solid state storage devices, such that said operating system supports access to said plurality of dissimilar solid state storage devices in a unified manner.

10. The computer-readable medium of claim 9, further comprising computer executable instructions for:
exposing an interface feature of said solid state storage device for the purpose of coupling said solid state storage device with a bus of a computer system.

11. The computer-readable medium of claim 9 wherein said computer-executable instructions for facilitating unified data access request communication between an operating system and a data access requester comprise computer-executable instructions for:
exposing a fixed nature of said solid state storage device.

12. The computer-readable medium of claim 9 wherein said computer-executable instructions for facilitating unified data access request communication between an operating system and a data access requester comprise computer-executable instructions for:
exposing a removable nature of said solid state storage device.

13. The computer-readable medium of claim 9 wherein said computer-executable instructions for facilitating unified data access request communication between an operating system and a data access requester comprise computer-executable instructions for:
facilitating booting a computer system from said solid state storage device.

14. The computer-readable medium of claim 9 wherein said computer-executable instructions for utilizing abstracted information regarding common functionalities of said plurality of dissimilar solid state storage devices comprise computer-executable instructions for:
defining a common communication protocol for uniformly accessing said plurality of dissimilar solid state storage devices.

15. A storage stack associated with an operating system, said storage stack comprising:
a file system;
a volume manger communicatively coupled to said file system;
a partition manager communicatively coupled to said volume manager; and
a solid state storage class driver communicatively coupled to said partition manager, said solid state storage class driver configured for supporting unified access through said operating system to a plurality of dissimilar solid state storage devices.

16. The storage stack of claim 15, wherein said solid state storage class driver comprises abstracted information regarding intrinsic characteristics of fixed solid state storage devices and abstracted information regarding intrinsic characteristics of removable solid state storage devices.

17. The storage stack of claim 15, further comprising:
a solid state storage port driver communicatively coupled to said solid state storage class driver, said solid state storage port driver providing an abstraction of a common functionality to said plurality of dissimilar solid state storage devices.

18. The storage stack of claim 17, wherein said solid state storage port driver defines a common communication protocol for uniformly accessing said plurality of dissimilar solid state storage devices with said operating system.

19. The storage stack of claim 17, further comprising:
a solid state storage mini-port driver communicatively coupled to said solid state storage port driver, said mini-port driver exposing a unique feature of a solid state storage device of said plurality of dissimilar solid state storage devices.

20. The storage stack of claim 19, further comprising:
a solid state storage bus driver communicatively coupled to said solid state storage port driver, said bus driver exposing an interface feature of a solid state storage device of said plurality of dissimilar solid state storage devices.
